(19) United States
(12) Patent Application Publication
(10) Pub. No.: US 2023/0269156 A1
(43) Pub. Date: Aug. 24, 2023

(54) NETWORK LATENCY MEASUREMENT METHOD AND APPARATUS FOR LOW LATENCY IMMERSIVE SERVICE

(71) Applicant: ELECTRONICS AND TELECOMMUNICATIONS RESEARCH INSTITUTE, Daejeon (KR)

(72) Inventors: Seung Woo HONG, Daejeon (KR); Tae Yeon KIM, Daejeon (KR); Ho Yong RYU, Daejeon (KR)

(21) Appl. No.: 18/080,902

(22) Filed: Dec. 14, 2022

(30) Foreign Application Priority Data
Feb. 23, 2022 (KR) 10-2022-0023442

(51) Int. Cl. H04L 43/0852

(52) U.S. Cl. CPC H04L 43/0858

(57) ABSTRACT

Disclosed are a network latency measurement method and apparatus for a low latency immersive service. The network latency measurement method includes transmitting a request message for measuring network latency from a first end node to a second end node, calculating a node latency at each node present between the first end node and the second end node and inserting the calculated node latency into the request message, and measuring a one-way network latency from the first end node to the second end node based on the node latency at each of the nodes inserted into the request message at the second end node.

### CROSS-REFERENCE TO RELATED APPLICATION

This application claims priority to and the benefit of Korean Patent Application No. 10-2022-0023442, filed on Feb. 23, 2022, the disclosure of which is incorporated herein by reference in its entirety.

### BACKGROUND

### 1. Field of the Invention

The present disclosure relates to a network latency measurement method and apparatus, and more specifically, a network latency measurement method and apparatus capable of measuring and providing network latency information of an end-to-end connection of an application service for a low latency immersive service in real time.

### 2. Description of Related Art

As data transmission with ultra-high speed, ultra-low latency, and hyper-connection becomes possible with the commercialization of 5G mobile communication, realistic services such as VR, AR, MR, and holograms are receiving a lot of attention as a new means of generating profits. In addition, as the COVID-19 pandemic has greatly reduced people's movement and social intercourse, and non-face-to-face services have expanded throughout society, such as telecommuting and remote meetings instead of offline activities, have been becoming commonplace, VR and AR-based remote immersive technology, which overcomes the limitations of distance and provides experiences such as manipulating robots or objects or meeting distant users in the same place and making face-to-face contact such as the metaverse, is emerging as an important core technology.

### SUMMARY OF THE INVENTION

The present invention is directed to a network latency measurement method and apparatus capable of measuring and providing network latency information of an end-to-end connection of an application service for a low latency immersive service in real time.

The technical tasks to be achieved in the present disclosure are not limited to the technical tasks mentioned above, and other technical tasks not mentioned will be clearly understood by those skilled in the art from the description below.

According to an aspect of the present invention, there are provided a network latency measurement method and apparatus for low latency realistic services. The network latency measurement method according to an embodiment of the present disclosure includes transmitting a request message for measuring network latency from a first end node to a second end node; calculating a node latency at each node present between the first end node and the second end node and inserting the calculated node latency into the request message; and measuring a one-way network latency from the first end node to the second end node based on the node latency at each node inserted into the request message at the second end node.

In this case, the inserting of the node latency into the request message may include a link latency with a previous node at each node and a buffer latency at the corresponding node.

In this case, the inserting of the node latency into the request message may include calculating, in a case of the last node between the first end node and the second end node, the node latency in consideration of the link latency with the previous node connected to an input interface and the link latency with the second end node connected to an output interface.

In this case, the node buffer delay may include a buffer latency range including a minimum buffer latency and a maximum buffer latency.

In this case, the measuring of the one-way network latency may include measuring the one-way network latency from the first end node to the second end node as a sum of node latencies calculated at each node.

Furthermore, the network latency measurement method may include transmitting a response message to the request message from the second end node to the first end node; calculating a response node latency at each node present in a first network path between the second end node and the first end node and inserting the calculated response node latency into the response message; and measuring a one-way network latency from the second end node to the first end node based on the response node latency at each node present in the first network path inserted into the response message at the first end node.

In this case, the transmitting of the response message from the second end node to the first end node may include allowing information on the measured one-way network latency from the first end node to the second end node to be included in the response message and transmitting the response message.

In this case, the information on the one-way network latency from the first end node to the second end node may include a total number of nodes present on a network path from the first end node to the second end node, a sum of total link latencies, and a sum of total buffer latencies.

A network latency measurement method according to another embodiment of the disclosure may include receiving a message transmitted from a first end node to measure network latency; extracting information on a node latency calculated at each node present between the first end node and a corresponding end node from the message; and measuring a one-way network latency from the first end node to the corresponding end node based on the extracted node latency at each node.

Furthermore, the network latency measurement method may further include allowing information on the measured one-way network latency to be included in another message corresponding to the received message and transmitting the other message.

A network latency measurement apparatus according to still another embodiment of the disclosure may include a reception unit configured to receive a message transmitted from a first end node to measure network latency; an extraction unit configured to extract information on a node latency calculated at each node present between the first end node and a corresponding end node from the message; and a measurement unit configured to measure a one-way network latency from the first end node to the corresponding end node based on the extracted node latency at each node.

The features briefly summarized above with respect to the disclosure are merely exemplary aspects of the detailed description of the disclosure to be described below, and do not limit the scope of the disclosure.

According to the disclosure, it is possible to provide a network latency measurement method and apparatus capable of measuring and providing, for a low latency real-time immersive application service, network latency information of an application service end-to-end connection in real time to satisfy latency requirements of the service.

Effects obtainable in the present disclosure are not limited to the effects mentioned above, and other effects not mentioned may be clearly understood by those skilled in the art from the description below.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating the configuration of one embodiment of a system for providing low latency interactive immersive service;

FIG. 2 is a diagram illustrating an embodiment of a service execution procedure between an immersive service server node and a client node;

FIG. 3 is a flowchart illustrating a network latency measurement method according to an embodiment of the present disclosure;

FIG. 4 is a diagram illustrating the definition of end-to-end network latency used in a network latency measurement protocol;

FIG. 5 is an exemplary diagram illustrating a one-way network latency measurement protocol from a first end node to a second end node;

FIG. 6 is a diagram illustrating the structure of an embodiment of a network latency measurement protocol message;

FIG. 7 is a diagram illustrating the configuration of a network latency measurement apparatus according to an embodiment of the present disclosure; and

FIG. 8 is a block diagram illustrating a device to which a network latency measurement apparatus according to an embodiment of the present disclosure is applied.

### DETAILED DESCRIPTION OF EXEMPLARY EMBODIMENTS

Hereinafter, exemplary embodiments of the present disclosure will be described in detail with reference to the accompanying drawings so that those skilled in the art may easily implement the present disclosure. However, the present disclosure may be embodied in many different forms and should not be construed as limited to the embodiments set forth herein.

In describing the embodiments of the present disclosure, when it is determined that a detailed description of a known structure or function may obscure the gist of the present disclosure, a detailed description thereof will be omitted. In the drawings, parts irrelevant to the description of the present disclosure are omitted, and like reference numerals designate like parts.

In the present disclosure, when a component is “connected,” “coupled” or “linked” to another component, it includes not only a direct connection, but also an indirect connection in which another component is present in the middle. In addition, when a component “includes” or “has” another component, it means that it may further include another component, without excluding the other component unless otherwise stated.

In the present disclosure, terms such as first and second are used only for the purpose of distinguishing one component from other components, and do not limit the order or importance of components unless specifically mentioned. Thus, within the scope of the present disclosure, a first component in one embodiment may be referred to as a second component in another embodiment, and likewise, a second component in one embodiment may be referred to as a first component in another embodiment.

In the present disclosure, components that are distinct from each other are for clearly describing each feature, and do not necessarily mean that the components are separated. That is, a plurality of components may be integrated into one hardware or software unit, or one component may be distributed and formed into a plurality of hardware or software units. Therefore, even if not mentioned otherwise, such integrated or distributed embodiments are included in the scope of the present disclosure.

In the present disclosure, components described in various embodiments are not necessarily required components, and some may be optional components. Accordingly, embodiments that consist of a subset of the components described in one embodiment are also included in the scope of the present disclosure. In addition, embodiments including other components in addition to the components described in the various embodiments are included in the scope of the present disclosure.

In the present disclosure, expressions of positional relationships used herein, such as upper, lower, left, right, etc., are mentioned for convenience of explanation, and when viewing the drawings shown in this specification in reverse, the positional relationship described in the specification may be interpreted in the opposite way.

The most important technical requirement for immersive services is to provide a seamless immersion experience to the extent that service users do not recognize that they are in a remote place. Compared to existing video and audio-based media contents, contents for immersive services have a large capacity that includes sensory information such as 3D information and tactile sensation. More importantly, along with the characteristics of a large amount of data, the response of the virtual world to a user's action, for example, an action of turning one's head to change a point of view or manipulating a virtual object or a real object, is required to have a real time property. This real time property has various requirements ranging from 1 ms to 100 ms according to the combination of senses, and in the case of a particularly important point of view, the real time property has requirements of less than 10 ms.

For the visual effect, which is a factor that has the greatest impact on human immersion, most immersive services commonly adopt a service model in which an immersive HMD is worn, and are aiming for content of full-view resolution of 12K to 14K or higher, a frame rate of 60 to 120 fps or more, and a field of view (FoV) of 120 degrees or more, which is an angle of view at which the user can see without moving their eyes when looking at one point. For example, in the case of 360-degree VR streaming, an HMD client terminal transmits sensing information such as the user's eyes and head movements to a streaming server, and the server transmits only the FoV currently viewed by the user among all content to the HMD device. As a result, compared to a full-view streaming method, the network bandwidth can be significantly reduced and the processing burden of the HMD device can be reduced. However, in this case, the latency time of motion-to-photon (MTP) is very important, and according to related studies, when a round trip time (RTT) is greater than 20 ms, users feel motion sickness and discomfort. Therefore, an ultra-low-latency delivery technology that guarantees RTT latency time within 10 to 20 ms can be said to be an important factor for the immersive service.

The latency of an immersive application service is divided into processing latency inside a terminal for media frames such as motion sensing, encoding, decoding, and display, and network latency for transmitting immersive content to a remote location. Since the terminal processing latency represents somewhat predictable processing performance depending on the performance of processing hardware and the algorithm of a used codec, and the measurement of processing latency time also makes it easy to measure the processing latency of each processing module inside the terminal that shares the same time, a module that requires a lot of processing latency due to a computing load can be optimized to satisfy required latency RTT, such as using dedicated hardware such as a GPU or adjusting the resolution of the content. However, in the network latency, since a difference in the latency may be greatly changed dynamically depending on network congestion, and application services do not have any information on the network status, it is difficult to perform optimization to satisfy the required latency RTT depending on the network latency situation. To cope with these difficulties, various application protocols such as HTTP, RTSP, HLS, DASH, WebRTC, RTP, RTMP, and SRP for streaming of immersive application services uses an RTT measurement method that calculates the time taken to send a control message between a server and a client and to return in a round trip to measure the dynamic latency time of the network. However, since this application process-based RTT measurement method cannot measure one-way transmission latency and cannot predict network latency that fluctuates according to network congestion and changes in transmission distance, there is a disadvantage that optimization cannot be performed in advance before congestion occurs. Therefore, in order to preemptively and actively deal with network latency to satisfy the latency requirements of the immersive services, a new approach is needed to measure and predict the status information of the network for the application service end-to-end connection in real time through direct interworking between the application service and the network.

According to embodiments of the present disclosure, it is possible to measure and provide network latency information of an application service end-to-end connection for a low-latency real-time immersive application service in real-time to satisfy latency requirements of the immersive service.

In this case, according to embodiments of the present disclosure, compared to the existing application process-based RTT measurement method, it is possible to provide more accurate real-time network latency information through a cross-layer method in which the network latency measurement protocol directly interworks with the network, and through the network latency information provided by the protocol, the immersive application process can preemptively and actively deal with the network latency to implement functions to satisfy the immersive service delay requirements.

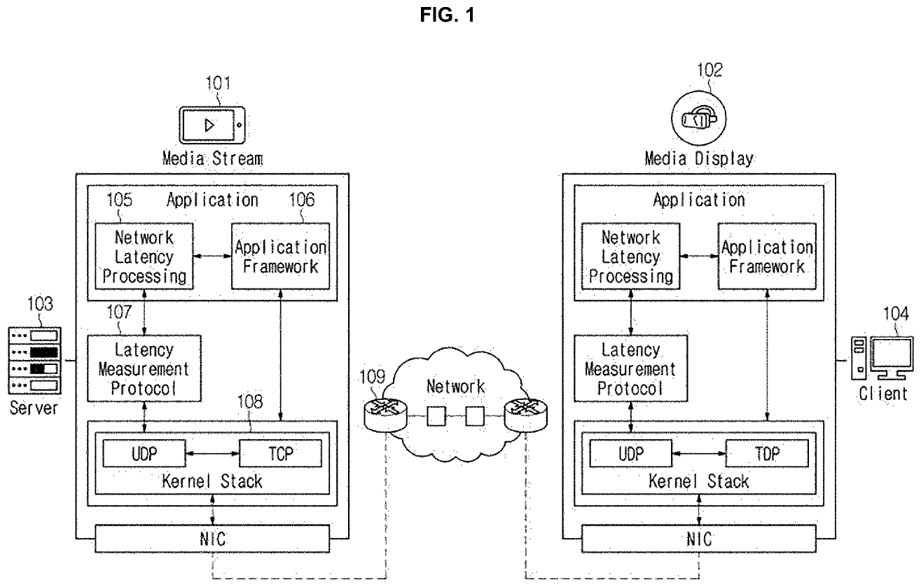

FIG. 1 is a diagram illustrating the configuration of one embodiment of a system for providing low latency interactive immersive service.

As show in FIG. 1, a media stream 101 providing an immersive service is present in a server node 103, and a media display device 102 for showing a corresponding media stream to the user is present in a client node 104. A network 109 for interconnection between remote locations is located between the server node 103 and the client node 104. A server application program and a client application program that provide actual immersive services are present inside each server node 103 and client node 104, and these application programs may use various application protocols for streaming immersive services, such as HTTP, RTSP, HLS, DASH, WebRTC, RTP, RTMP, and SRP.

In the embodiment of the present disclosure, the application protocols can be used in any structure without being limited to a specific immersive service streaming protocol and framework, and these application protocols and frameworks are collectively referred to as an application framework 106. A transmission latency measurement protocol 107 (hereinafter, referred to as “LMP”) corresponding to the network latency measurement apparatus according to the embodiment of the present disclosure is located below the application program to provide network latency information to the application program. The application program includes network latency processing 105 (hereinafter, referred to as “NLP”) for processing the network latency information of the LMP 107 together with the existing application framework 106 and transmitting the processed network latency information to the application framework 106. Below the LMP 107 and the application program, a transport layer protocol 108 such as UDP and TCP for transmitting actual control and media data through a network and a network interface card (NIC) are present.

When a method in which the immersive service is performed in the structure of the system shown in FIG. 1 is described using the case of the motion-to-photon (MTP) (Here, MTP refers to the operation of changing and streaming an area changed according to the movement of the field of view) 20 ms latency target as an example, the application framework 106 may analyze the current service latency situation by integrating network latency information transmitted by the LMP along with media processing latency such as encoding and decoding, which are processed by itself, and may perform optimization such as media resolution adjustment and transmission rate adjustment in order to achieve the final target latency time (e.g., 20 ms). Such optimization may be performed through various algorithms, and detailed descriptions thereof are omitted in the embodiments of the present disclosure because they may distract from the subject matter of the present disclosure.

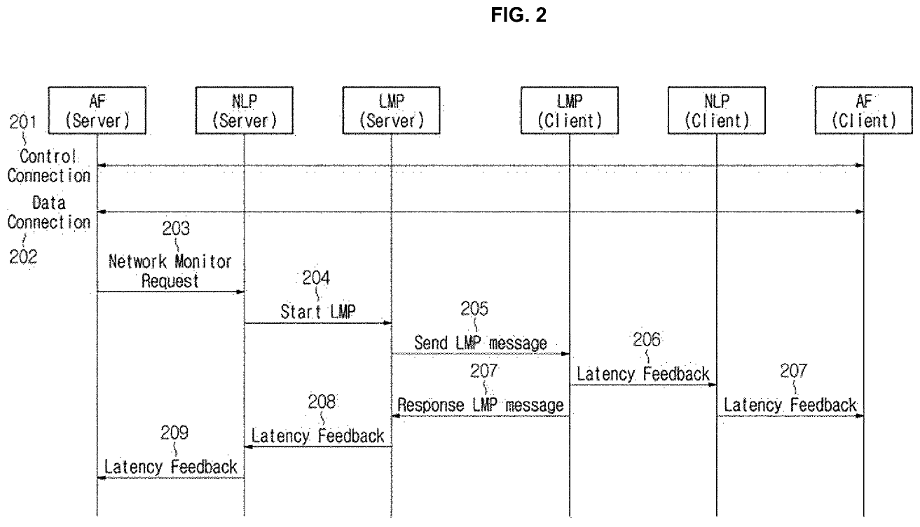

FIG. 2 is a diagram illustrating an embodiment of a service execution procedure between an immersive service server node and a client node, and illustrates service execution procedures between an application framework (AF), network latency processing (NLP), and a latency measurement protocol (LMP) present in each of the immersive service server node and the client node.

As shown in FIG. 2, a control connection setting 201 is performed for exchanging control signals, such as a media stream request between an initial server node and an application framework (AF) of a client node, and in general, a control connection may use a reliable TCP-based connection. After that, in a case in which there is a media stream connection request from the client, a data connection setting 202 for transmitting the stream data is performed, and in general, a data connection may use a UDP-based connection for high-speed transmission. When the control connection 201 and the data connection 202 are established, a server AF transmits a network monitor request 203 to the server NLP to obtain network latency information. The server NLP having received the request 203 transmits a request 204 for starting measurement of real-time network latency information to the server LMP, and the server LMP transmits an LMP protocol message 205 to the client LMP.

When the client LMP receives the LMP protocol message 205, network latency information 206 in the corresponding protocol message is transmitted to the client NLP. Accordingly, the client NLP processes the network latency information through its own algorithm, predicts future network conditions, and transmits the network latency information 207 to the client AF requesting the actual media stream. The client AF may perform optimization through various methods, such as changing the media stream format, in consideration of the received network latency information and computing processing latency such as a codec measured by itself. The client LMP having received the LMP protocol message 205 from the server LMP transmits the network latency information to the client NLP and simultaneously transmits the LMP response protocol message 207 to the server LMP. The server LMP having received the corresponding response message 207 transmits network latency information 208 to the server NLP in the same way, and the server NLP processes the network latency information and transmits network latency information 209 to the server AF.

As described above, the server AF and the client AF having received the network latency information may perform optimization to satisfy mutual latency requirements through various algorithms. When the server LMP and the client LMP start the protocol to measure the initial real-time network latency information, the network latency information is measured in real-time through periodic LMP request and response messages, and the measured network latency information is periodically transmitted to an AF through an LMP.

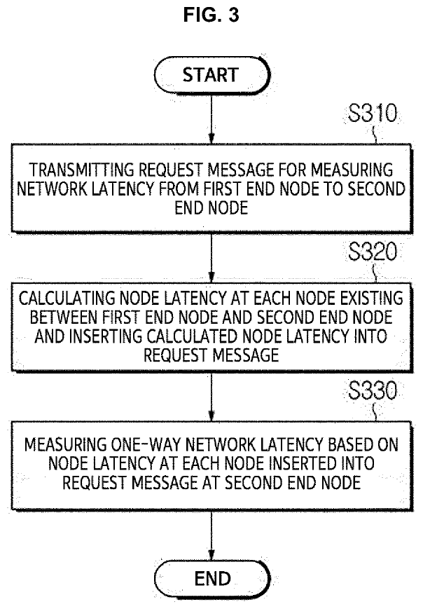

FIG. 3 is a flowchart illustrating a network latency measurement method according to an embodiment of the present disclosure. In FIG. 2, a process of measuring a one-way network latency at a client node through a process of transmitting an LMP request message from a server node (a first end node) to a client node (a second end node) is illustrated.

Referring to FIG. 3, in operation S310 of the network latency measurement method according to an embodiment of the present disclosure, a request message (LMP request message) for measuring network latency is transmitted from a first end node to a second end node.

When the LMP request message is transmitted in operation S310, a node latency is calculated at each node present on a network path between the first end node and the second end node and the calculated node latency is inserted into the request message, and thus the request message including the node latency information of each node is transmitted to the second end node in operation S320.

In this case, operation S320 may calculate a node latency including a link latency required for a network link at each node and a node buffer latency caused by switching and buffering of the network node.

In this case, in operation S320, in the case of the last node among the nodes from the first end node to the second end node, the node latency may be calculated in consideration of both the link latency with the previous node connected to an input interface and the link latency with the second end node connected to an output interface.

The LMP of the second end node, that is, the client node, receives a request message, and a one-way network latency from the first end node to the second end node is measured based on the node latency of each node inserted into the request message in operation S330.

In this case, in operation S330, the one-way network latency may be measured as a sum of the node latencies of each node inserted into the request message.

Specifically, in operation S330, the request message is received, information on the node latency calculated at each node inserted into the request message is extracted, and then, based on the extracted node latency at each node, the one-way network latency from the first end node to the second end node may be measured based on the extracted node latency at each node.

Similarly, by transmitting a response message (LMP response message) for measuring the network latency from the second end node to the first end node, the one-way network latency from the second end node to the first end node is measured through the above-described process. In addition, when a message for measuring the network latency is transmitted to another end node after the one-way network latency is measured at any one end node, the one-way network latency information measured at the one end node may be included and transmitted.

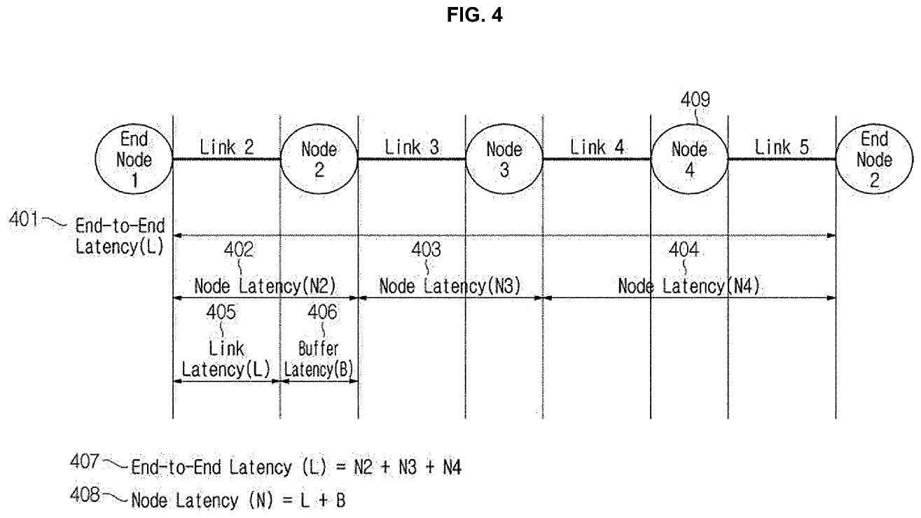

A network latency measurement method according to an embodiment of the present disclosure, in which one-way network latency is measured through this process, will be described in detail with reference to FIGS. 4 to 6.

FIG. 4 is a diagram illustrating the definition of end-to-end network latency used in a network latency measurement protocol.

As shown in FIG. 4, an end-to-end network latency 401 refers to the transmission latency time required in a network between end terminals in which an application program (server or client) is performed, that is, a first end node (End Node 1) and a second end node (End Node 2). Such an end-to-end network latency may be divided into a link latency required in a network link and a buffer latency at a corresponding node caused by switching and buffering of a network node. The end-to-end network latency 401 may be defined as the sum of all link latencies and all buffer latencies. When the end-to-end network latency is separated into one network node, one network node may have one link latency and one buffer latency. For example, the network node latency of Node 2 may be divided into a link latency occurring in Link 2 between the first end node (End Node 1) and Node 2 and a buffer latency occurring in Node 2. Similarly, the network node latency of Node 3 may be divided into a Link 3 link latency and a Node 3 buffer latency, and the network node latency of Node 4 409 may be divided into a Link 4 link latency and a Node 4 buffer latency. Therefore, the total end-to-end network latency can be obtained by summing the node latencies of all nodes on the network path. In this case, in the case of Node 4 409, which is the last node on the network path, the node latency may be calculated based on both the link latency (Link 4) with Node 3 connected to the input interface and the link latency (Link 5) with the second end node connected to the output interface. That is, the link latency calculated at Node 4 409 may include link 4 and link 5.

The node latency (N) 408 at each node may be defined or calculated as the sum of the link latency (L) 405 and the buffer latency (B) 406, and the end-to-end latency (L) 407 may be defined or calculated as the sum (N2+N3+N4) of the node latencies of all nodes present on the network path. That is, as shown in FIG. 4, the end-to-end latency between the first end node and the second end node may be measured as the sum of the node latency 402 of Node 2, the node latency 403 of Node 3, and the node latency 404 of Node 4. At this time, the second end node may measure a one-way network latency from the first end node to the second end node using the sum of node latencies of each node inserted into the request message transmitted from the first end node, and the first end node may measure a one-way network latency from the second end node to the first end node using the sum of the node latencies of each node inserted into a response message transmitted from the second end node.

The one-way network latency from the first end node to the second end node may be measured using the method described in FIG. 4, and the one-way network latency from the second end node to the first end node may be also measured in a direction from the second end node to the first end node using the method described in FIG. 4. That is, since the link latency or the buffer latency at each node may vary according to a network latency measurement direction, the one-way network latency from the first end node to the second end node and the one-way network latency from the second end node to the first end node may be the same or different.

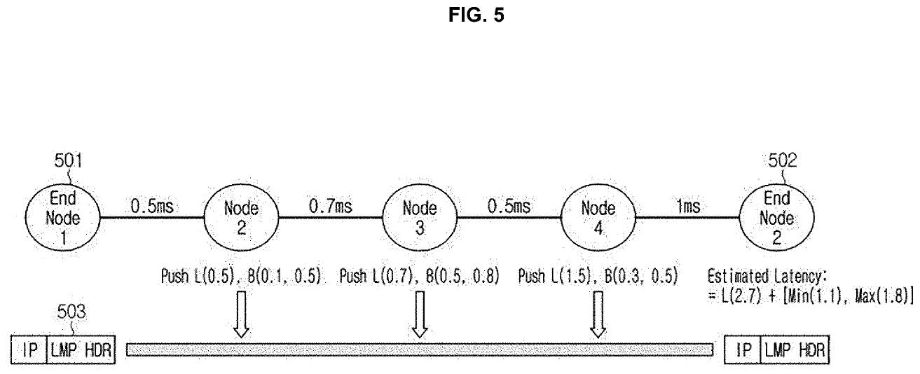

FIG. 5 is an exemplary diagram illustrating a one-way network latency measurement protocol from a first end node to a second end node.

Referring to FIG. 5, network latency is measured by transmitting protocol request and response messages between LMPs of application end nodes where a server or a client application program is executed, and the LMP operates at a first end node 501 and a second end node 502.

The LMP of the first end node 501 transmits a request message for measuring a predefined network latency, for example, a network latency measurement protocol message, to the second end node 502. The request message or request protocol message is transmitted from all network nodes on the network path to the second end node 502 through switching. Each node on the network path inserts node latency information required by each node into a corresponding request message. As shown in FIG. 4, the node latency information is divided into a link latency 405 and a buffer latency 406. The link latency is a latency that occurs in the link path and may vary depending on the length of the link and the medium of the link, such as an optical cable. The link latency may be known using various methods such as calculating through a simple link length, for example, calculating using 300 km/1 ms, or using a separate protocol. In the buffer latency, when a congestion situation occurs and there is a lot of traffic to be processed, the waiting time becomes longer due to buffering, and in the opposite case, corresponding data is processed and transmitted immediately without waiting time in the buffer, so that the buffer latency may be calculated through the length of the buffer queue and switching capacity. Measurement of link latency and buffer latency may be performed in various ways, and since this is obvious to those skilled in the art engaged in the technology of the present disclosure, detailed description thereof will be omitted. At this time, since the buffer latency changes in real time according to the network situation, the buffer latency is defined with two parameters, Min Buffer Latency and Max Buffer Latency, to indicate the range of buffer latency that can be handled by each network node. The advantage of classifying the buffer latency into minimum (Min) and maximum (Max) is to provide a method in which, in the case where the network node can handle QoS, when immersive media traffic is desired to be transmitted with a lower latency, processing is performed with Min latency corresponding to the minimum latency, and in the case of a comfortable circumstance, a request may be made so that processing is handled as a general situation.

When the link latency and buffer latency measured at each network node in a specific way are inserted into a corresponding request protocol message 503 processed by each network node and the LMP of the second end node 502 finally receives the request protocol message, the one-way network latency from the first end node 501 to the second end node 502 may be known by obtaining the sum of link latency and buffer latency. For example, at Node 2, the range L (0.5) and B (0.1, 0.5) of the link latency and the buffer latency are calculated and inserted into a request protocol message 603, at Node 3, the range L (0.7) and B (0.5, 0.8) of the link latency and the buffer latency are calculated and inserted into the request protocol message 603, and at Node 4, the range L (1.5) and B (0.3, 0.5) of the link latency and buffer latency are calculated and inserted into the request protocol message 503, whereby the LMP of the second end node 502 may measure the node latency sum of L(2.7)+[Min(1.1), Max(1.8)] as the one-way network latency from the first end node 501 to the second end node 502.

When the LMP of the second end node 502 obtains the one-way network latency, the LMP transmits the obtained one-way network latency to the AF of the second end node 502 and transmits a response protocol message for the corresponding request protocol message from the second end node 502 to the first end node 501, and the LMP of the first end node 501 having received the response protocol message may measure the one-way network latency from the second end node 502 to the first end node 501. Since each request protocol message and response protocol message include the previously calculated one-way latency information, the LMP of the first end node 501 and the LMP of the second end node 502 may finally know the bi-directional network latency. For example, after the one-way network latency is measured at the second end node 502, the message transmitted to the first end node 501 may include information on the one-way network latency measured at the second end node 502, and after the one-way network latency is measured at the first end node 501, the message transmitted to the second end node 502 may include information on the one-way network latency measured at the first end node 501.

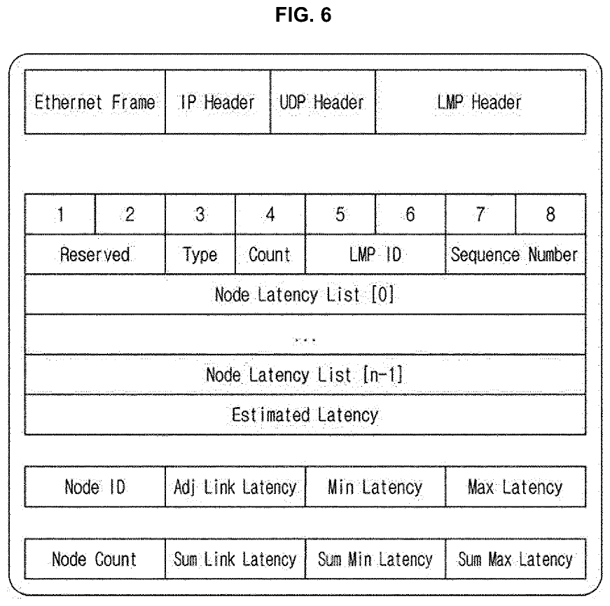

FIG. 6 is a diagram illustrating the structure of an embodiment of a network latency measurement protocol message. Since the LMP has its own packet numbering system, the LMP uses UDP instead of TCP. Therefore, LMP Header is located after Ethernet Header, IP Header, and UDP Header, and the contents of each field of the LMP header are as follows.

Reserved: Reserved field for future expansion

Type: Message type (request message 0, response message 1)

Count: The number of network nodes, incremented by 1 each time a network node is passed

LMP ID: Identifier for distinguishing a specific LMP connection from multiple LMP connections

Sequence Number: Message sequence, incremented by 1

Node Latency List: Node latency information list of each network node

Node ID: network node ID

Adj Link Latency: Network Node Link Latency

Min Latency: Network Node Buffer Min Latency

Max Latency: Network Node Buffer Max Latency

Node Count: Total number of nodes in reverse direction

Node Sum Link Latency: Sum of total link latency in reverse direction

Sum Min/Max Latency: Sum of total Buffer Min/Max Latency in reverse direction

Here, Node Count, Node Sum Link Latency, and Sum Min/Max Latency are fields used when a one-way network latency is calculated at any one end, for example, the second end node, and then a corresponding message is transmitted to the other end, for example, the first end node, and are fields to which the total number of measured nodes, the sum of total transmission link latencies, and the sum of total Buffer Min/Max Latency are input when the one-way network latency is measured at the first end node. If necessary, Node ID can also be used when transmitting the message to another end.

As described above, the network latency measurement method according to an embodiment of the present disclosure may measure and provide the network latency information of an application service end-to-end connection for a low-latency immersive service in real-time, and thus the following effects can be derived.

First, the network latency measurement method according to an embodiment of the present disclosure, in a low-latency real-time ultra-immersive application service, may measure and provide network latency information for an application service end-to-end connection in real-time by proactively and proactively coping with the network latency to satisfy the latency requirements of the immersive service.

Second, the network latency measurement method according to an embodiment of the present disclosure may provide more accurate network latency information provided by the network through a cross-layer method in which the LMP protocol of an end-to-end application terminal directly interworks with the network compared to the existing application process-based RTT measurement method.

Third, in the existing application process-based RTT measurement method, since the network latency is measured in such a manner that a corresponding message is transmitted while a time stamp is added to the message by a transmission side and the current time and time stamp are compared for the returned message, only the round trip latency may be measured. However, in the network latency measurement method according to the present disclosure, measurement may be performed based on one-way latency. One-way latency may be used as an important factor because a transmission network path and a reception network path may differ from each other in an actual network.

Fourth, the network latency measurement method according to an embodiment of the present disclosure may provide various types of of network information such as the number of network nodes on the network transmission path, the length of the transmission path (link latency), the congestion condition of each network node (buffer latency), etc., compared to the existing application process-based RTT measurement method, thereby providing a basis for implementing various optimization techniques.

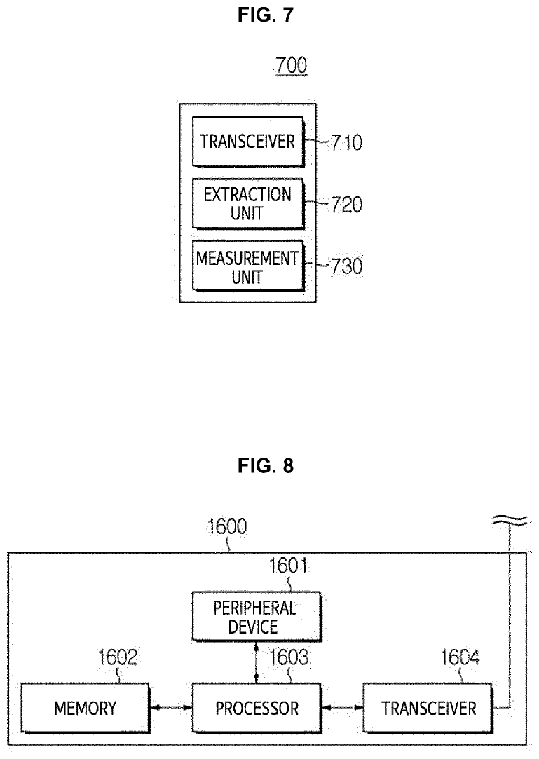

FIG. 7 is a diagram illustrating the configuration of a network latency measurement apparatus according to an embodiment of the present disclosure, and is a diagram illustrating a conceptual configuration of the LMP of the server or the client illustrated in FIG. 1.

Referring to FIG. 7, a network latency measurement apparatus 700 according to an embodiment of the present disclosure includes a transceiver 710, an extraction unit 720, and a measurement unit 730.

The transceiver 710 receives, in order to measure network latency, a message transmitted from a first end node, for example, a server node or a client node, at a corresponding end node, and transmits another message corresponding to the received message to the first end node.

For example, when the corresponding end node is the client node, the transceiver 710 may receive a request message for measuring network latency from the server node that is the first end node, and may transmit a response message to the request message to the server node. In this case, when transmitting the response message to the server node, the transceiver 710 may include information on the one-way network latency from the server node measured by the LMP of the client to the client node, for example, the number of nodes present on the network path a direction from the server node to the client node, a sum of total link latencies calculated at each node, and a sum of total buffer latencies calculated at each node, in the response message, and may transmit the response message.

The extraction unit 720 extracts information on the node latency calculated at each node present between the first end node and the corresponding end node, from the message received through the transceiver 710, for example, the request message or the response message.

For example, the extraction unit 720 extracts Node Latency List [0] to Node Latency List [n−1], which are pieces of information on node latency, from the LMP Header of the message shown in FIG. 6.

Furthermore, when the information on the one-way network latency measured at the first end node is included in the received message, the extraction unit 720 may also extract the information on the one-way network latency measured at the first end node, for example, the total number of nodes present on the network path in a direction from the corresponding end node to the first end node, a sum of total link latencies calculated at each node, and a sum of total buffer latencies calculated at each node.

The measurement unit 730 measures the one-way network latency from the first end node to the corresponding end node based on the node latency at each node extracted by the extraction unit 720.

In this case, the measurement unit 730 may measure the one-way network latency using a sum of link latencies and a sum of node buffer latencies included in the node latency at each node.

Although a description thereof is omitted in FIG. 7, the network latency measurement apparatus according to an embodiment of the present disclosure may include all contents described in FIGS. 1 to 6.

FIG. 8 is a block diagram illustrating a device to which a network latency measurement apparatus according to an embodiment of the present disclosure is applied.

For example, the network latency measurement apparatus according to the embodiment of the present disclosure of FIG. 7 may be a device 1600 of FIG. 8. Referring to FIG. 8, the device 1600 may include a memory 1602, a processor 1603, a transceiver 1604, and a peripheral device 1601. In addition, as an example, the device 1600 may further include other components, and is not limited to the above-described embodiment. In this case, the device 1600 may be, for example, a mobile user terminal (e.g., a smartphone, a laptop computer, a wearable device, etc.) or a fixed management device (e.g., a server, a PC, etc.).

More specifically, the device 1600 of FIG. 8 may be an exemplary hardware/software architecture such as an immersive service providing server, a virtual content providing server, a virtual reality game server, an HMD, an immersive service client terminal, and the like. At this time, for example, the memory 1602 may be a non-removable memory or a removable memory. In addition, as an example, the peripheral device 1601 may include a display, GPS, or other peripheral devices, and is not limited to the above-described embodiment.

In addition, as an example, the above-described device 1600 may include a communication circuit like the transceiver 1604, and based on this, communication with an external device may be performed.

In addition, as an example, the processor 1603 may be at least one of a general purpose processor, a digital signal processor (DSP), a DSP core, a controller, a microcontroller, application specific integrated circuits (ASICs), field programmable gate array (FPGA) circuits, any other type of integrated circuit (IC), and one or more microprocessors associated with a state machine. That is, the processor 1603 may be a hardware/software configuration that performs a control role for controlling the device 1600 described above. In addition, the processor 1603 may modularize and perform the functions of the extraction unit 720 and the measurement unit 730 of FIG. 7.

At this time, the processor 1603 may execute computer executable instructions stored in the memory 1602 to perform various essential functions of the network latency measurement apparatus. For example, the processor 1603 may control at least one of signal coding, data processing, power control, input/output processing, and communication operations. In addition, the processor 1603 may control a physical layer, a MAC layer, and an application layer. In addition, as an example, the processor 1603 may perform authentication and security procedures in an access layer and/or an application layer, and is not limited to the above-described embodiment.

For example, the processor 1603 may communicate with other devices through the transceiver 1604. For example, the processor 1603 may control the network latency measurement apparatus to communicate with other devices through a network through execution of computer executable instructions. That is, the communication performed in the present disclosure may be controlled. For example, the transceiver 1604 may transmit an RF signal through an antenna and may transmit the signal based on various communication networks.

In addition, as an example, MIMO technology, beamforming, etc., may be applied as an antenna technology, and is not limited to the above-described embodiment. In addition, the signal transmitted and received through the transceiver 1604 may be modulated and demodulated and controlled by the processor 1603, and is not limited to the above-described embodiment.

Exemplary methods of this disclosure are presented as a series of operations for clarity of explanation, but this is not intended to limit the order in which steps are performed, and each step may be performed concurrently or in a different order, if desired. In order to implement the method according to the present disclosure, other steps may be included in addition to the exemplified steps, other steps may be included except for some steps, or additional other steps may be included except for some steps.

Various embodiments of the present disclosure are intended to explain representative aspects of the present disclosure rather than listing all possible combinations, and details described in various embodiments may be applied independently or in combination of two or more.

In addition, various embodiments of the present disclosure may be implemented by hardware, firmware, software, or a combination thereof. For implementation by hardware, various embodiments of the present disclosure may be implemented by one or more application specific integrated circuits (ASICs), digital signal processors (DSPs), digital signal processing devices (DSPDs), programmable logic devices (PLDs), field programmable gate arrays (FPGAs), a general processor, a controller, a microcontroller, a microprocessor, and the like.

The scope of the present disclosure includes software or machine-executable instructions (e.g., operating systems, applications, firmware, programs, etc.) that cause the operation according to the method according to various embodiments to be performed by a device or on a computer, and a non-transitory computer-readable medium that stores such software or instructions and is executable by the device or on the computer.

### DESCRIPTION OF REFERENCE NUMERALS

107: Latency measurement protocol (LMP)
700: Network latency measurement apparatus
710: Transceiver
720: Extraction unit
730: Measurement unit

What is claimed is:

1. A method for measuring network latency, comprising:
transmitting a request message for measuring network latency from a first end node to a second end node;
calculating a node latency at each node present between the first end node and the second end node and inserting the node latency into the request message; and
measuring a one-way network latency from the first end node to the second end node based on the node latency at each of the nodes inserted into the request message at the second end node.

2. The method of claim 1, wherein the inserting of the request message includes calculating the node latency including a link latency with a previous node at each of the nodes and a buffer latency at a corresponding node.

3. The method of claim 2, wherein the inserting of the request message includes calculating, in a case of the last node between the first end node and the second end node, the node latency in consideration of the link latency with the previous node connected to an input interface and the link latency with the second end node connected to an output interface.

4. The method of claim 2, wherein the buffer latency includes a buffer latency range including a minimum buffer latency and a maximum buffer latency.

5. The method of claim 1, wherein the measuring of the one-way network latency includes measuring the one-way network latency from the first end node to the second end node as a sum of the node latencies calculated at each of the nodes.

6. The method of claim 1, further comprising:
transmitting a response message to the request message from the second end node to the first end node;
calculating a response node latency at each node present on a first network path between the second end node and the first end node, and inserting the calculated response node latency into the response message; and
measuring a one-way network latency from the second end node to the first end node based on the response node latency at each node present on the first network path inserted into the response message at the first end node.

7. The method of claim 6, wherein the transmitting of the response message from the second end node to the first end node includes allowing information on the measured one-way network latency from the first end node to the second end node to be included in the response message, and transmitting the response message.

8. The method of claim 7, wherein the information on the measured one-way network latency from the first end node to the second end node includes the total number of nodes present on a network path from the first end node to the second end node, a sum of total link latencies, and a sum of total buffer latencies.

9. A method for measuring network latency, comprising:
receiving a message transmitted from a first end node to measure network latency;
extracting information on a node latency calculated at each node present between the first end node and a corresponding end node from the message; and
measuring a one-way network latency from the first end node to the corresponding end node based on the node latency at each node.

10. The method of claim 9, wherein the node latency includes a link latency with a previous node and a buffer latency at the corresponding end node.

11. The method of claim 10, wherein the buffer latency includes a buffer latency range including a minimum buffer latency and a maximum buffer latency.

12. The method of claim 9, further comprising:
allowing information on the measured one-way network latency to be included in another message corresponding to the received message, and transmitting the message to the first end node.

13. The method of claim 12, wherein the information on the measured one-way network latency includes the total number of nodes present between the first end node and the corresponding end node, a sum of total link latencies, and a sum of total buffer latencies.

14. A apparatus for measuring network latency measurement, comprising:
a reception unit configured to receive a message transmitted from a first end node to measure network latency;
an extraction unit configured to extract information on a node latency calculated at each node present between the first end node and a corresponding end node; and
a measurement unit configured to measure a one-way network latency from the first end node to the corresponding end node based on the node latency at each node.

15. The apparatus of claim 14, wherein the node latency includes a link latency with a previous node and a buffer latency at the corresponding end node.

16. The apparatus of claim 15, wherein the buffer latency includes a buffer latency range including a minimum buffer latency and a maximum buffer latency.

17. The apparatus of claim 14, further comprising:
a transmission unit configured to allow information on the measured one-way network latency to be included in another message corresponding to the received message and transmit the message to the first end node.

18. The apparatus of claim 17, wherein the transmission unit allows the information on the measured one-way network latency including the total number of nodes present between the first end node and the corresponding end node, a sum of total link latencies, and a sum of total buffer latencies, to be included in the other message, and transmits the message.
